(19) United States
(12) Patent Application Publication
(10) Pub. No.: US 2022/0315486 A1
(43) Pub. Date: Oct. 6, 2022

(54) METHOD FOR PRODUCING HYDRAULIC COMPOSITION

(71) Applicant: Tokuyama Corporation, Shunan-shi, Yamaguchi (JP)

(72) Inventors: Akiyoshi MORI, Shunan-shi (JP); Takashi CHABAYASHI, Shunan-shi (JP); Takuya SEKI, Shunan-shi (JP); Hiroyoshi KATO, Shunan-shi (JP)

(21) Appl. No.: 17/608,787

(22) PCT Filed: Apr. 9, 2020
(86) PCT No.: PCT/JP2020/015907

§ 371 Date: Nov. 4, 2021

(30) Foreign Application Priority Data
May 31, 2019 (JP) 2019-101932

(51) Int. Cl. C04B 11/30; C04B 7/32; C04B 7/52; C04B 24/12

(52) U.S. Cl. CPC C04B 11/30; C04B 7/32; C04B 7/52; C04B 24/121

(57) ABSTRACT

A clinker that has a total content of C₃A and C₄AF of 22 to 40 mass %, calculated according to Bogue's formulas, and an iron modulus of 0.8 to 1.3 is pulverized with gypsum. Alternatively, the clinker after pulverization is mixed with gypsum powder. A pulverization agent comprising N-methyl-di-ethanol-amine and/or di-ethanol-isopropanol-amine is used in the pulverization.

### FIELD OF THE INVENTION

The present invention relates to a method for producing a hydraulic composition.

### BACKGROUND ART

The cement industry is mass-producing and mass-consuming; resource-saving and energy-saving are its most important issues. For example, in the production of Portland cement, the most widely produced cement, the raw material having an adjusted and predetermined chemical composition is heated at 1450-1550 degree Celsius to produce the clinker. This heating step is the most energy-consuming. In other words, if the heating temperature of the clinker can be lowered, then, energy-saving is achieved. For lowering the heating temperature for producing the clinker, the technology that increases the C₄AF (4CaO—Al₂O₃—Fe₂O₃) content, one of the main components of the clinker, has been developed (for example, Patent Document 1: JP 5665,638B and U.S. Pat. No. 8,864,902B).

In relation to the recent global environmental issues, the effective ways of use of wasted materials and by-products have been required. To use effectively and to dispose safely wasted materials as the raw material or fuel for cement production have been considered a way of safe and mass disposal of wasted materials, utilizing the characteristics of cement production equipment of the cement industry. By the way, many wasted materials and by-products have high Al₂O₃ contents. Since the above cement system having increased C₄AF content in the cement clinker needs a higher Al₂O₃ content than that of the ordinary Portland cement clinker, therefore, the production of the above cement system can use a more quantity of wasted materials and by-products than the ordinary Portland cement clinker. This is another superiority of the clinker according to Patent Document 1.

In the pulverization step of Portland cement production, di-ethylene-glycol has been mainly used as the pulverization agent, and tri-ethanol-amine and tri-isopropanol-amine have also been used in some cases, for improving the pulverization efficiency of the cement clinker (see Non-Patent Document 1, and Patent Documents 2 and 3, for example). Patent Document 4 refers to di-ethanol-isopropanol-amine as a pulverization agent of cement clinker, and Patent Document 5 refers to N-methyl-di-ethanol-amine as a pulverization agent of cement clinker.

### PRIOR DOCUMENTS

### Patent Documents

| | | |
|---|---|---|
| Patent Document 1: | JP 5665,638B | (US 8864,902B) |
| Patent Document 2: | JP 5024,669B | |
| Patent Document 3: | JP 2017-210,398A | |
| Patent Document 4: | WO 2010-085425A | (US 8993,656B) |
| Patent Document 5: | WO 2012-008517A | (US 8506,701B) |

### Non-Patent Documents

Non-Patent Document 1: Handbook of Ceramics, 2nd Edition, P. 231, Left Column, Edited by Ceramic Society of Japan, Published by Gihodo Shuppan Co. Ltd. 31, Mar. 2002.

### SUMMARY OF THE INVENTION

### Problem to be Solved by the Invention

The present inventors and others have found the problem that the strength on the 28th day of mortar is not enough when using conventional di-ethylene-glycol or tri-ethanol-amine as the pulverization agent, regarding the clinker having the mineral composition described in Patent Document 1. Further, it has been found that tri-isopropanol-amine improves the strength to some extent but that at the same time it has a problem in pulverizability.

In addition, the improvement in the curability for better workability has been required; in particular, the shortening of the period until the coagulation starts without an expensive accelerator has been required.

Therefore, the object of the invention is to provide a production method of a hydraulic composition that uses the clinker can be produced at a lower temperature than conventional Portland cement clinkers and has good strength development property, good pulverizability, and also good coagulation property.

### Means for Solving the Problem

The present inventors have considered solving the problem and have found that a new pulverization agent comprising a specific compound, namely N-methyl-di-ethanol-amine and/or di-ethanol-isopropanol-amine, improves the pulverizability of the cement clinker and also improves curability and strength development property of the resultant hydraulic composition.

In the production method of a hydraulic composition of the present invention, a clinker having a total content of C₃A and C₄AF of 22 to 40 mass %, calculated according to Bogue's formulas, and an iron modulus of 0.8 to 1.3, is pulverized with gypsum. Alternatively, gypsum powder and said clinker after pulverization may be mixed. The present invention is characterized in that a pulverization agent comprising N-methyl-di-ethanol-amine and/or di-ethanol-isopropanol-amine is used in the pulverization.

### Advantageous Effects of the Invention

According to the invention, the cement clinker that has a higher content of C₃A and C₄AF, can use a more quantity of wasted materials and by-products, and is produced at a lower temperature than conventional Portland cement clinker is well pulverized, and the produced hydraulic composition has a good curability and a good strength development property.

### BEST MODE FOR CARRYING OUT THE INVENTION

The mineral contents of C₃A, C₄AF, C₃S, and so on, are calculable according to Bogue's formulas.

Bogue's formulas have been used along with various indexes and various moduli and allow the calculation of approximate chemical composition from major chemically analyzed values. While Bogue's formulas have been well-known to the ordinary persons in the art, they will be listed. In the formulas and in this specification, the unit of CaO, SiO₂, and so on, are mass %.

C₃S quantity=(4.07×CaO)−(7.60×SiO₂)−(6.72×Al₂O₃)−(1.43×Fe₂O₃).

C₂S quantity=(2.87×SiO₂)−(0.754×C₃S).

C₃A quantity=(2.65×Al₂O₃)−(1.69×Fe₂O₃).

C₄AF quantity=3.04×Fe₂O₃.

The iron modulus (I.M.), the hydraulic modulus (H.M.), the silica modulus (S.M.), the activity index, and the lime saturation degree (L.S.D.) are calculated according to major chemically analyzed values. While they have been well-known to the ordinary persons in the art, they will be listed as follows.

Hydraulic Modulus (H.M.)=CaO/(SiO₂+Al₂O₃+Fe₂O₃).

Silica Modulus (S.M.)=SiO₂/(Al₂O₃+Fe₂O₃).

Iron Modulus (I.M.)=Al₂O₃/Fe₂O₃.

Activity Index (A.I.)=SiO₂/Al₂O₃.

Lime Saturation Degree (L.S.D.)=CaO/(2.8×SiO₂+1.2×Al₂O₃+0.65×Fe₂O₃).

The above CaO, SiO₂, Al₂O₃, and Fe₂O₃ contents can be measured according to JIS R 5202 “Chemical Analysis of Portland Cement”, JIS R 5204 “ Fluorescent X-ray Analysis of Cement”, or the like.

The clinker used in the inventive production method includes 22 to 40% of C₃A and C₄AF in total. When the total amount of them is under 22%, the production of the clinker having good properties such as strength development property becomes difficult at a heating temperature of 1300 to 1400 degree Celsius. Their total content is preferably 24% or more. As will be described later, the C₃S content is preferably 60% or more for improved strength development property. Therefore, the total content of C₃A and C₄AF is 40% or less, preferably, 35% or less, particularly preferably, 32% or less, and, most preferably, 27% or less. Since C₄AF contributes enough sintering at the lower temperature and also the reduction of free-CaO content in the clinker, C₄AF is, preferably, present 15% or more in the clinker and, more preferably, present 16% to 18%.

The C₃S quantity affects strongly the strength development property of the hydraulic composition. In the clinker used in the inventive production method, this quantity is preferably made 60% or more for good strength development property. The C₃S quantity is more preferably 61% or more and, most preferably, 62% or more. Since the total content of C₃A and C₄AF is at least 22%, the upper limit of C₃S is 78%. The C₃S content is preferably 70% or less for ensuring the period from the start of cure to the end of the cure and, more preferably, 65% or less.

The hydraulic composition used in the inventive production method can further include C₂S. Its quantity is preferably 18% or less and 3% or more. For the improved long-term strength, the total content of C₂S and C₃S is preferably 70% or more.

The iron modulus (I.M.) in the clinker used in the inventive production method is 0.8 to 1.3. When the iron modulus exceeds 1.3, the strength development property (in particular, the mortar strength development property) is not achieved enough, even if other conditions are satisfied. In addition, when the iron modulus (I.M.) exceeds 1.3, the period from the start of cure and to the end of cure tends to be too long, and, therefore, the iron modulus is 1.3 or less. The preferable range of iron modulus is 1.0 to 1.3 and, more preferably, 1.14 to 1.27.

The hydraulic modulus and the silica modulus in the clinker used in the inventive production method are not particularly limited. For achieving a good balance between various properties, the hydraulic modulus is preferably 1.8 to 2.2 and, more preferably, 1.9 to 2.1, and the silica modulus is preferably 1.0 to 2.0 and, more preferably, 1.1 to 1.7.

The production method of the clinker used in the inventive production method is not particularly limited, and adequate known production methods can be used.

The clinker raw material can be prepared and mixed according to adequate known methods. In particular, raw materials such as wasted materials, by-products, and others (lime-stone, quick lime, slaked lime, and other CaO sources, silica stone and other SiO₂ sources, clay, coal ash, and other Al₂O₃ sources, copper slag, blast furnace slag, and other Fe₂O₃ sources) are chemically analyzed. The mixing ratio of raw materials is calculated from the composition of each raw material such that the requirements to the clinker composition are satisfied, and the raw materials are mixed by the mixing ratio.

The raw materials used in the production are those which have been used in the production of cement clinker and are not particularly limited. Wasted materials and by-products are of course usable.

Particular examples of appropriate wasted materials and by-products are blast furnace slag; steel slag; manganese slag; coal ash; sewage sludge; waterworks sludge; paper sludge; soil waste from construction; waste casting sand; soot and dust; incinerated fly ash; molten fly ash; chlorine by-path dust; wood; waste white clay; coal debris; waste tires; seashells; and municipal waste and its incinerated ash. Some of them are used as cement raw materials and also as thermal energy sources.

According to conventional production methods of clinker, the mixture of raw materials, such as above, are heated at 1450 degree Celsius or the like temperature for a predetermined period in a furnace (for example, an SP-kiln or an NSP-kiln). The resultant clinker is rapidly cooled to 200 degree Celsius or the like temperature at a cooling rate of 100 degree Celsius or more by a cooling device called a clinker cooler (for example, an air blower or a sprinkler).

When producing the clinker where the total content of C₃A and C₄AF is 22 to 40% and the iron modulus (I.M.) is 0.8 to 1.3, the heating temperature can, however, be lowered to 1300 to 1400 degree Celsius, and energy-saving is achieved.

The hydraulic composition produced by the inventive method is produced by the pulverization of the clinker produced as above with gypsum or by the pulverization of the clinker and mixing subsequently the pulverized clinker with gypsum powder. These steps themselves are the same as conventional production methods of cement compositions.

The most important character in the inventive production method is to use N-methyl-di-ethanol-amine and/or di-ethanol-isopropanol-amine is used as the pulverization agent in the pulverization of the clinker.

When using the inventive pulverization agent, superior curability and better compression strength when cured for 28 days are resultant compared with conventional di-ethylene-glycol pulverization agent, which has been used widely as the pulverization agent of clinker. In comparison with tri-ethanol-amine and tri-isopropanol-amine, the inventive pulverization agent makes the coagulation start more rapidly and makes the curability and the strength development property improved. In particular, the compression strengths on the seventh day to the 28th day from the start of the cure are superior. Further, N-methyl-di-ethanol-amine affords good pulverizability.

In the production method of the hydraulic composition according to the invention, the amount of use of the inventive pulverization agent is, for example, the same as that of conventional pulverization agent. For example, when producing Portland cement according to JIS standard as the hydraulic composition, the amount of use of the pulverization agent is less than 1 mass % in the Portland cement.

In particular, 0.001 to 0.05 mass part of the inventive pulverization agent is preferably used for 100 mass parts of the clinker, and, more preferably, 0.01 to 0.04 mass part of the inventive pulverization agent is used. When using 0.001 mass part or more of the inventive pulverization agent, very good pulverizability, curability, and strength development property are resultant. When using more than 0.05 mass part of the inventive pulverization agent, the curability and the strength development property are sometimes lowered.

Gypsum that can be used in the production method according to the invention is di-hydrate gypsum, semi-hydrate gypsum, and/or anhydrous gypsum, for example. Gypsum known as a raw material of cement can be used without any particular limitation. The amount of use of gypsum can be determined arbitrarily according to the usage of the hydraulic composition from the known ranges. For example, when producing Portland cement, gypsum is used such that the SO3 quantity in the cement is made 1.5 to 5.0 mass % and, more preferably, 1.8 to 3.0 mass %.

For pulverizing the above cement clinker and gypsum, known pulverization apparatuses such as a high-speed rotation pulverizer, a mill where a container is driven, a jet mill, and a roller mill are used. Known pulverizers can be used without any specific limitation.

The hydraulic composition is generally and preferably pulverized to Blaine's specific surface area of 2800 to 4500 cm²/gr, while the degree of pulverization is arbitrary. The clinker or the mixture of clinker and gypsum is pulverized to the above range.

The hydraulic composition according to the invention may include a small amount of additives such as blast furnace slag, siliceous mixtures, fly ash, calcium carbonate, and lime-stone. These small amount of additives can be pulverized with the clinker or mixed into the pulverized clinker. Further, chlorine by-path dust or the like can be added.

The resultant hydraulic composition is usable for ordinary Portland cement, early strength Portland cement, and super early strength Portland cement. In addition to Portland cement, the cement is usable for various types of mixed cement and as an ingredient of solidification agents such as soil solidification agents.

The resultant hydraulic composition produced according to the invention is usable as blast furnace slag cement or fly ash cement with mixing blast furnace slag or fly ash after the pulverization.

### EMBODIMENTS

The features and advantageous effects of the invention will be described with reference to the following embodiments; the scope of the invention is not limited by these embodiments.

### Pulverization Agents

The following pulverization agents were used:

DEG; di-ethyline-glycol;

MDEA: N-methyl-di-ethanol-amine;

DEIPA: di-ethanol-isopropanol-amine;

TEA: tri-ethanol-amine; and

TIPA: tri-isopropanol amine

### Measurement Methods of the Properties

Various properties were measured as follows.

(1) Chemical Compositions of the Clinkers and the Hydraulic Compositions: X-ray fluorescence analysis according to JIS R 5204 was used.

(2) Pulverizability: 2 kg of each clinker, a predetermined amount of gypsum, and the pulverization agent were pulverized in a ball mill. The needed periods (in minute unit) until Blaine's specific surface area became 3100 cm²/gr were measured as the pulverizability and are indicated as BL3100.

(3) Curability: The periods needed for coagulation of hydraulic compositions were measured according to JIS R 5201; the periods until the coagulation started were made the values of the curability.

(4) Strength Development Property: The mortar compression strengths were measured according to JIS R 5201 regarding each mortar on various curing days.

### Production of Clinker

Lime-stone, silica stone, coal ash, and steel slag were mixed to prepare the raw materials such that they have the mineral compositions in Table 1 after the heating. The raw materials were heated at 1350 degree Celsius (clinker A) or 1450 degree Celsius (clinker B) in an electric furnace for 1.5 hr into the clinkers.

TABLE 1
(Clinkers)

| | Heating Temp. | Bogue's Formulas | | | | Three Moduli | | |
|---|---|---|---|---|---|---|---|---|
| | (degree Celsius) | C₃S | C₂S | C₃A | C₄AF | H.M. | S.M. | I.M. |
| Clinker A | 1350 | 64.3 | 8.9 | 7.8 | 16.4 | 2.06 | 1.69 | 1.18 |
| Clinker B | 1450 | 64.1 | 16.2 | 8.4 | 9.1 | 2.2 | 2.8 | 1.7 |

### Production of Hydraulic Compositions

Into the clinkers, gypsum (di-hydrate/semi-hydrate=1) was added such that the gypsum concentrations became 2.0 plus-minus 0.2 mass % in reduction to SO₃ and the pulverization agent of 0.03 mass part to 100 mass parts of the clinkers was added. The mixtures were pulverized in a ball mill until Blaine's specific surface area became 3200 plus-minus 50 cm²/gr and thus made the hydraulic compositions.

### Conventional Examples 1 to 5

The clinker B was conventional and had a usual mineral composition. Various pulverization agents were added to produce hydraulic compositions. The pulverization agents used, pulverizability, and properties of the hydraulic compositions are listed in Table 2.

TABLE 2*

| | Pulverization | Pulverizability | Curability | Mortar Compression Strength (N/mm²) | | | |
|---|---|---|---|---|---|---|---|
| | Agent | BL3100 | Start (min.) | Cured 1 day | 3 day | 7 day | 28 day |
| Con. 1 | DEG | 70.9 | 90 | 13.3 | 27.8 | 47.1 | 67.7 |
| Con. 2 | MDEA | 70.3 | 100 | 13.2 | 26.6 | 46.5 | 70.8 |
| Con. 3 | DEIPA | 76.5 | 105 | 12.8 | 27.6 | 50.6 | 71.8 |
| Con. 4 | TEA | 73.6 | 115 | 14.1 | 26.8 | 45.1 | 69.8 |
| Con. 5 | TIPA | 78.3 | 115 | 12.7 | 24.2 | 45.7 | 71.9 |

*Clinker B was used.

### Embodiments 1 and 2, Comparative Examples 1 to 3

Various pulverization agents were added into the clinker A that was heated at 1350 degree Celsius, a lower temperature than that of the clinker B, to produce hydraulic compositions. The pulverization agents used, pulverizability, and properties of the hydraulic compositions are listed in Table 3.

TABLE 3*

| | Pulverization | Pulverizability | Curability | Mortar Compression Strength (N/mm²) | | | |
|---|---|---|---|---|---|---|---|
| | Agent | BL3100 | Start (min.) | Cured 1 day | 3 day | 7 day | 28 day |
| Em. 1 | MDEA | 68.0 | 75 | 11.5 | 27.8 | 47.0 | 69.8 |
| Em. 2 | DEIPA | 72.6 | 60 | 11.4 | 27.4 | 48.2 | 70.3 |
| Com. 1 | DEG | 68.2 | 100 | 13.0 | 29.5 | 45.1 | 63.0 |
| Com. 2 | TEA | 73.6 | 90 | 13.8 | 30.9 | 46.1 | 65.4 |
| Com. 3 | TIPA | 78.3 | 95 | 11.5 | 25.2 | 44.4 | 68.2 |

*Clinker A was used.

As shown in Table 3, regarding the clinker A, when MDEA or DEIPA was used as the pulverization agent, the periods needed till the start of coagulation were shortened compared with other pulverization agents; the curability was improved. This tendency was not observed regarding the conventional clinker B (conventional examples in Table 2) and was a characteristic feature peculiar to the clinker A.

The compression strengths on the 28th day increased by 10% or more compared with DEG pulverization agent. The increase in the compression strengths was, however, 5 or 6% when MDEA or DEIPA was used to the clinker B. This indicates MDEA and DEIPA have significant strength improvement effects.

Moreover, when MDEA was used as the pulverization agent, the pulverizability was very good. While the chemical structure of TEA (tri-ethanol-amine) is intermediate between those of MDEA (N-methyl-di-ethanol-amine) and DEIPA (di-ethanol-isopropanol-amine), however, regarding the clinker A, MDEA and DEIPA have remarkably different properties in the curability and the strength on the 28th day from those of TEA (Table 3). On the contrary, regarding the clinker B, there are no remarkable differences between MDEA and DEIPA, and TEA as the pulverization agents (Table 2). Thus, MDEA and DEIPA are specifically effective pulverization agents for the clinker B.

What is claimed is:

1. A method for producing a hydraulic composition, performing a step for pulverizing a clinker having a total content of C₃A and C₄AF of 22 to 40 mass %, calculated according to Bogue's formulas, and an iron modulus of 0.8 to 1.3, with gypsum, or alternatively, mixing gypsum powder and said clinker after being pulverized,
wherein a pulverization agent comprising N-methyl-di-ethanol-amine and/or di-ethanol-isopropanol-amine is used in the pulverization.

2. The method for producing the hydraulic composition according to claim 1, being characterized in that the total content of N-methyl-di-ethanol-amine and di-ethanol-isopropanol-amine is 0.001 mass part to 0.05 mass part to 100 mass parts of said clinker.

3. The method for producing the hydraulic composition according to claim 2, being characterized in that the total content of N-methyl-di-ethanol-amine and di-ethanol-isopropanol-amine is 0.01 mass part to 0.04 mass part to 100 mass parts of said clinker.

4. The method for producing the hydraulic composition according to claim 1, being characterized in that said pulverization agent substantially consists of at least one member selected from the group of N-methyl-di-ethanol-amine and di-ethanol-isopropanol-amine.

5. The method for producing the hydraulic composition according to claim 4, being characterized in that said pulverization agent consists of at least one member selected from the group of N-methyl-di-ethanol-amine and di-ethanol-isopropanol-amine.

6. The method for producing the hydraulic composition according to claim 1, being characterized in that N-methyl-di-ethanol-amine is used as said pulverization agent.
